(19) United States
(12) Patent Application Publication
(10) Pub. No.: US 2026/0118672 A1
(43) Pub. Date: Apr. 30, 2026

(54) AUGMENTED REALITY (AR) DISPLAYS WITH NON-TARGET SUB-PIXEL LIGHT BLOCKING

(71) Applicant: Toyota Motor Engineering & Manufacturing North America, Inc., Plano, TX (US)

(72) Inventor: Sean P. Rodrigues, Ann Arbor, MI (US)

(21) Appl. No.: 18/930,219

(22) Filed: Oct. 29, 2024

(51) Int. Cl. G02B 27/01

(52) U.S. Cl. CPC G02B 27/0172; G02B 2027/0178

(57) ABSTRACT

Systems, methods, and other embodiments described herein relate to AR display devices and methods that generate digital images on a transparent liquid crystal (LC) substrate with low-power components. In one embodiment, a method includes identifying target pixels of a transparent LC substrate. The target pixels define a digital content region of the transparent LC substrate. The method also includes identifying, per target pixel, a target sub-pixel that aligns with a color sub-section, of a multi-color filter that overlays the transparent LC substrate, that matches a target color for the target pixel. The method also includes 1) setting LCs of the transparent LC substrate that align with the target sub-pixel to a light transmission state and 2) setting LCs that align with non-target sub-pixels to a light-blocking state.

### TECHNICAL FIELD

The subject matter described herein relates, in general, to augmented reality (AR) displays and, more particularly, to low-power transparent AR displays that improve viewability by setting non-target sub-pixels to a light-blocking state.

### BACKGROUND

Augmented reality (AR) is an interactive experience where the real-world environment of an individual is enhanced with digital content. In one particular example, the AR experience may be within a visual environment of the individual. In this example, computer-generated images, texts, animations, etc., may be generated on a transparent substrate through which a user views a scene. As such, the individual views the environment through the transparent substrate and also views the digital content presented on the transparent substrate.

AR may be used in a variety of scenarios. For example, a vehicle may include a heads-up display where digital warnings and notifications may be presented on a display through which a driver sees the road in front of them. In another example, AR may be used in a medical setting where similar warnings, notifications, and instructions may be provided to the surgeon on a transparent display through which the surgeon views a patient.

In general, developments in AR systems may increase their use in society, both in fields where AR systems are currently used and in new fields where AR system utility may not be thoroughly explored.

### SUMMARY

In one embodiment, example systems and methods relate to a manner of improving AR display devices as described.

In one embodiment, an AR display device is disclosed. The AR display device includes a transparent liquid crystal (LC) substrate divided into pixels that are further divided into individually addressable sub-pixels. The AR display device also includes a set of oppositely-polarized polarizers. Each polarizer is on either side of the transparent LC substrate. The AR display device also includes a multi-color filter. The multi-color filter is divided into sections that are further divided into sub-sections. Color filter sub-sections align with individually addressable sub-pixels. The AR display device also includes a controller. The controller selectively sets LCs that align with target sub-pixels to a light transmission state. A target sub-pixel is within a digital content region of the transparent LC substrate and defines a color for a target pixel within the digital content region. The controller also selectively sets LCs that align with non-target sub-pixels to a light-blocking state.

In one embodiment, an AR display device to be worn on the head of a user is disclosed. The AR display device includes a frame to be worn on the head of a user and a supplemental light source mounted to the frame. The AR display device also includes a transparent LC substrate divided into pixels that are further divided into individually addressable sub-pixels. The AR display device also includes a set of oppositely-polarized polarizers. One polarizer is on either side of the transparent LC substrate. The AR display device also includes a multi-color filter. The multi-color filter is divided into sections that are further divided into sub-sections. Color filter sub-sections align with individually addressable sub-pixels. The AR display device also includes a controller. The controller selectively sets LCs that align with target sub-pixels to a light transmission state. A target sub-pixel is within a digital content region of the transparent LC substrate and defines a color for a target pixel within the digital content region. The controller also selectively sets LCs that align with non-target sub-pixels to a light-blocking state.

In one embodiment, a method for generating digital content on a transparent LC substrate is described. According to the method, a controller identifies the target pixels of a transparent LC substrate. The target pixels define a digital content region of the transparent LC substrate. The method also identifies, per target pixel, a target sub-pixel that aligns with a color sub-section of a multi-color filter that overlays the transparent LC substrate and matches a target color for the target pixel. The method also includes 1) setting LCs of the transparent LC substrate that align with the target sub-pixel to a light transmission state and 2) setting LCs that align with non-target sub-pixels to a light-blocking state.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an AR display device with a user-facing supplemental light source according to an example of the principles described herein.

FIG. 2 illustrates the state of various LCs of an AR display device according to an example of the principles described herein.

FIG. 3 illustrates the state of various LCs of an AR display device according to an example of the principles described herein.

FIG. 4 illustrates one embodiment of an AR display device with a transflector according to an example of the principles described herein.

FIG. 5 illustrates one embodiment of an AR display device according to an example of the principles described herein.

FIG. 6 illustrates one embodiment of a controller of the AR display device according to an example of the principles described herein.

FIGS. 7A and 7B depict polarizers and transparent LC substrate of the AR display device, according to an example of the principles described herein.

FIG. 8 illustrates a flowchart for one embodiment of a method that is associated with generating digital content on an AR display device according to an example of the principles described herein.

FIG. 9 illustrates a flowchart for one embodiment of a method that is associated with generating digital content on an AR display device according to an example of the principles described herein.

### DETAILED DESCRIPTION

Devices, methods, and other embodiments associated with improving the presentation of augmented reality content on a transparent liquid crystal (LC) substrate are disclosed herein. As previously described, an augmented reality (AR) display presents digital content on top of a real-world environment viewed by a user through a transparent display. Put another way, an AR display system overlays digital content over a view of a physical environment. There are various types of AR displays. In one example, an AR display may be an optical see-through type of display where a user views reality through optical elements that enable the graphic overlay of the content. As another example, an AR display may be a video see-through where the user views reality that is captured by a camera mounted on the display, which camera views are combined with computer-generated content.

While the potential uses of AR displays are endless and exciting, some aspects may limit their complete implementation in society. For example, one developing field is wearable AR displays, for example as a headset. While a portable AR system is exciting and innovative, AR headsets can be heavy and uncomfortable for a user. Moreover, the components that generate and display the AR content may be power-hungry, meaning that the portable AR systems may require a significant power supply, which may be burdensome and uncomfortable to a user.

Even further, the computer-generated content may become washed out in daylight or well-lit conditions. That is, a user may have difficulty seeing the digital content in ambient sunlit conditions due to the lack of contrast between the generated content and the environmental light. This may reduce the utility of any AR display device as the ability to see the generated content is diminished and, in some cases, eliminated.

Accordingly, the AR display device of the present specification describes a low-power, energy-efficient AR display system that a user may wear without discomfort and that overlays high-quality computer-generated content on a transparent lens worn by the user (e.g., glasses). The AR display device of the present specification increases the visibility of the computer-generated content by darkening regions around the digital content, thus increasing the contrast and viewability of such. For example, to display a computer-generated navigational arrow on AR glasses to be worn by a user, a controller may block light transmission through regions of the transparent substrate surrounding the navigational arrow. Doing so increases the contrast of the digital content (e.g., the navigational arrow) with the immediately adjacent regions of the display screen, thus making the digital content easier to see.

In this example, rather than using an external light source to illuminate the digital content, the present AR display device relies on ambient light to illuminate the pixels. That is, existing display systems may rely on an external light source to illuminate the pixels of a display surface. For example, a transmissive display may include a backlight, and a reflective display may include a light source on the user side of the display surface. Both systems include large light sources, which may be a source of energy consumption. The present system, by comparison, relies on ambient light to illuminate the pixels and darkens surrounding pixels to provide additional clarity and contrast. This reduces the energy consumption of the system, allowing a smaller, lighter-weight controller to be implemented, thus improving the user's comfort.

The display system generally includes a first polarizer on the environment side of a transparent LC substrate and a second polarizer on the display or user side of the transparent LC substrate. The polarization of the polarizers may be different. For example, the first polarizer on the scene-side of the transparent LC substrate may be a horizontal polarizer that allows horizontally polarized ambient light to pass through. In contrast, the second polarizer on the user-side of the transparent LC substrate may be a vertical polarizer that allows vertically polarized ambient light to pass through. While particular reference is made to a horizontal polarizer on the scene-side and a vertical polarizer on the user-side of a transparent LC substrate, these polarizers may be switched (i.e., a vertical polarizer on the scene-side and a horizontal polarizer on the user-side).

Accordingly, the first polarizer (e.g., the horizontal polarizer) transmits horizontally polarized ambient light. The horizontally polarized ambient light passes through a transparent liquid crystal (LC) substrate. Liquid crystals are molecules whose orientation changes under the influence of an electrical current. The changed orientation alters how light is transmitted through the LC layer. Accordingly, when an electric current is applied to the liquid crystals, the liquid crystals may switch between states (e.g., 1) from a light-blocking state where light polarity is maintained to a light transmission state where light polarity is changed or 2) from a light transmission state to a light-blocking state).

The liquid crystal substrate may be divided into pixels. Each pixel is divided into individually addressable sub-pixels. A group of liquid crystals may be found in each sub-pixel region. The liquid crystals change state when an electric current is applied to a sub-pixel. Liquid crystals in non-electrified sub-pixel regions do not change state. Those sub-pixels that define the digital image may be set in a state (e.g., by applying or removing an electrical current) to alter the polarization of the light passing therethrough.

The transmitted ambient light then interacts with the second polarizer (e.g., a vertical polarizer). For those sub-pixels where the associated liquid crystals altered the transmitted ambient light from horizontally to vertically polarized, the ambient light transmits through the second polarizer toward the user. By comparison, the ambient light that passes through sub-pixels that do not alter light polarization, the ambient light remains horizontally polarized and is blocked by the second (e.g., vertical) polarizer. Accordingly, the system can either present a digital image or a transmissive window by selectively allowing ambient light to pass through the polarizers and transparent LC substrate through target pixels and target sub-pixels that map to the image pixels.

As described in more detail below, the AR display device may further include a multi-color filter divided into sections. Each color filter section is divided into filter sub-sections, with each sub-section comprising a particular color filter (e.g., red, green, or blue) or no filter. By activating LC sub-pixels that align with individual color filter sub-sections, particular wavelengths of the ambient light (as dictated by an associated color filter sub-pixel) may be directed towards the user, presenting a colorized digital image. For those regions outside of a digital content region, the controller may allow all light that impinges upon the transparent substrate to pass through. In this example, the transparent LC substrate acts as a window with a tint and/or reduced light transmission due to the polarizers.

However, as described above, due to a lack of contrast in a naturally lit environment, it may be difficult to view the digital content. Accordingly, a controller of the present display device may selectively maintain the LCs in pixels that form a border region around the digital content in a state where light polarization is unaltered. In other words, light passing through the boundary regions surrounding the digital content is blocked by the second polarizer because the LC state is not altered and appears black to the user, thus increasing the contrast and making the digital image more readily viewable. Moreover, LCs in regions surrounding the border region may be set to a state where ambient light polarization is altered. Doing so results in the regions surrounding the border region allowing all ambient light in, thus appearing transparent.

In other words, the present system 1) sets select LC sub-pixels that define digital content in a state to alter the transmitting ambient light in a way to generate colorized digital content, 2) sets LC sub-pixels that define a boundary of the computer-generated content to a light-blocking state to increase contrast and viewability of the digital content, and 3) sets all LC sub-pixels in pixel regions outside the boundary region to a light transmission state to allow the transmitted ambient light to pass unaltered or at a reduced brightness on account of the properties of the polarizers.

In some examples, the AR display device further includes a transflector (also known as a transreflector, halfway mirror, or one-way mirror) and a supplemental light source on the user side of the transparent LC substrate. The transflector may allow the ambient pixel-illuminating light to transmit through the transparent LC substrate and reflect light from the supplemental light source on the user side of the transparent LC substrate. In another example, the AR display device 1) does not include the transflector and 2) the supplemental light source is on an environment-side of the transparent LC substrate directed towards the user.

In this way, the disclosed systems, methods, and other embodiments provide a low-power AR display device. By eliminating a constantly active backlight, the current systems, methods, and other embodiments eliminate a portion of the energy consumption that may be present in other AR display systems. Moreover, a simplified controller, which consumes less energy, is implemented and adjusts LC substrate sub-pixels in a particular fashion. Moreover, the system, by blocking light transmission in a boundary region around digital content, enhances the viewability and contrast of the digital content to the surrounding environment viewed through the transparent LC substrate.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

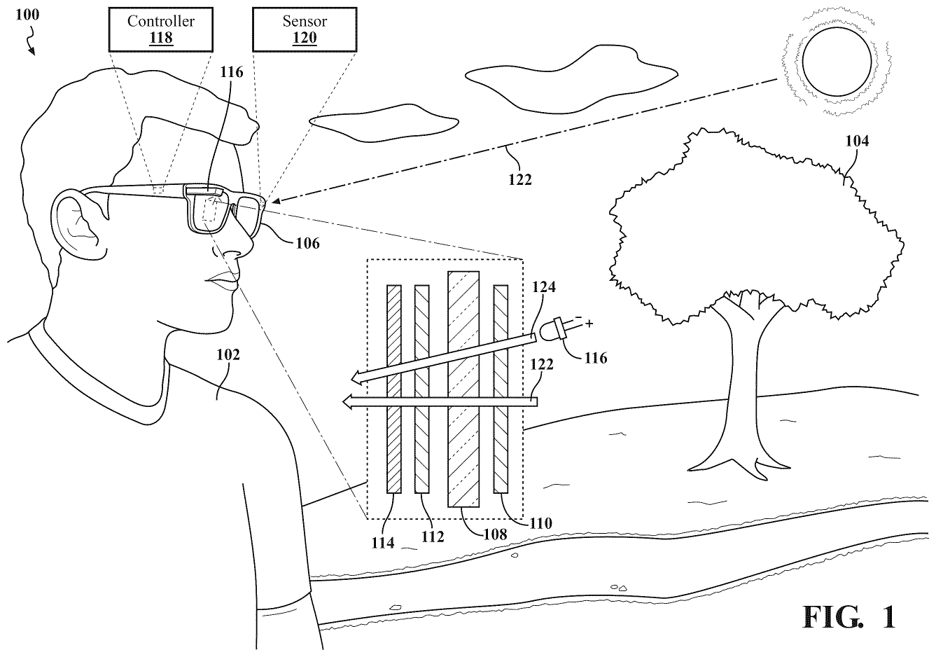

Turning now to the figures, FIG. 1 illustrates one embodiment of an AR display device 100 with a user-facing supplemental light source 116 according to an example of the principles described herein.

As described above, AR display devices 100 present digital content on a transparent LC substrate through which a user 102 views an environment 104. For example, the AR display device 100 may include a frame 106 to be worn on the head of the user 102. An example of such a system may be eyeglasses worn by the user 102. The AR display device 100 includes a transparent LC substrate 108 through which the user may view an environment 104, such as that depicted in FIG. 1. While particular reference is made to an AR display device 100 worn on the head of a user 102, the AR display device 100 may take different forms such as a tablet, computer screen, etc. In an example, the AR display device 100 may cover the entirety of the eyeglasses, while in other examples, the AR display device 100 may occupy a portion of the eyeglasses.

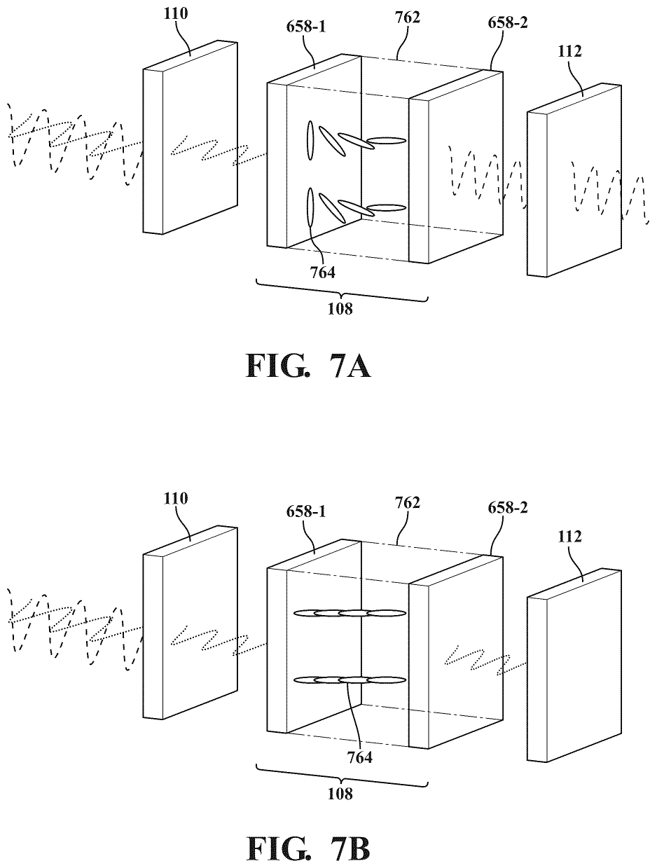

In either case, the AR display device 100 includes a transparent LC substrate 108. As described above, and in more detail in connection with FIGS. 7A and 7B, the transparent LC substrate 108 is made up of liquid crystals that change orientation responsive to an applied electrical current. The orientation of the LCs defines how they alter light passing through. For example, in an “off” state, the LCs may be aligned with one another and generally parallel to the light beams entering therein. In this example, the LCs do not change the polarization of the ambient light 122. As described below, unaltered ambient light 122 and supplemental light source light 124 may be blocked by the second polarizer 112. By comparison, in an “on” state, the LCs may not be aligned with one another, or otherwise in a state where they change the polarization of the incoming ambient light 122 and supplemental light source light 124. Specifically, the LCs change the polarization of light to match that of the second polarizer 112, such that altered-polarization light impinging upon the surface of the second polarizer 112 is transmitted through to the user 102.

In an example, the state of the LCs may be defined by the presence or lack of an electrical current. For example, LCs may be “on” when an electrical current is applied and may be “off” in the absence of an electrical current. In another example, the LCs may be “off” when an electrical current is applied and may be “on” in the absence of an electrical current.

In an example, the transparent LC substrate 108 is divided into pixels, which pixels are further divided into individually addressable sub-pixels. That is, a sub-pixel defines a region of the transparent LC substrate 108 that can be individually targeted by associated electrodes as depicted in FIGS. 7A and 7B. For example, a first sub-pixel may be “on” or set to a light transmission state (e.g., and switch the polarization of light transmitted through that first sub-pixel), while a second sub-pixel that is adjacent the first sub-pixel is “off” or in a light-blocking state and therefore does not switch the polarization of light that passes through the second sub-pixel.

The digital content is created by selectively activating certain target sub-pixels of target pixels that define the digital content. That is, digital content may be divided into content pixels, where each content pixel falls within the digital content and is assigned a color value (e.g., R, G, or B). The controller 118 receives a content file that identifies the content pixels and associated colors for the content pixels. The controller 118 then converts the content pixel data into AR display device pixel data so that the target pixels of the transparent LC substrate 108 that define the digital content are identified. The controller 118 then sets certain target sub-pixels corresponding to the target pixels that define the digital content to a light transmission state. As such, light transmits through the target sub-pixels but not others. The transmission of light through target sub-pixels thus generates the content on the transparent LC substrate 108.

In an example, the voltage applied across the electrodes may be other than a binary (e.g., on or off) value. Instead, the voltage may be discretized to tunably adjust the light intensity. For example, the relative intensity that the controller provides may normalize the light intensity that is identified by a sensor (such as an external-facing camera or set of photodetectors). In this example, the sensor may have the same color filters that are present in the display. Accordingly, the normalized intensity output from the controller is passed to a voltage driver for the electrodes. As such, light transmits through the target sub-pixels but not others. The transmission of light through target sub-pixels thus generates the content on the transparent LC substrate 108.

As described above, the AR display device 100 also includes a set of oppositely-polarized polarizers 110 and 112, a polarizer 110 and 112 on either side of the transparent LC substrate 108. For example, a first polarizer 110 may be formed on a scene side of the transparent LC substrate 108, while a second polarizer 112 may be formed on a user side of the transparent LC substrate 108. Each polarizer may be a thin film polarizer that is adhered to the surface of the transparent LC substrate 108. In general, the polarization of a light beam refers to the orientation of the light waves. A polarizer is an optical filter that lets light waves of a particular polarization or orientation pass through while blocking light waves of other polarizations. In an example, the first polarizer 110 may have a different polarization than the second polarizer 112. That is, the first polarizer 110 may allow light waves of one orientation to pass through, while the second polarizer 112 allows light waves of a different orientation to pass through. As a specific example, the first polarizer 110 may be a horizontal polarizer, while the second polarizer 112 is a vertical polarizer. The combination of the oppositely-polarized polarizers 110 and 112 and the transparent LC substrate 108 define the image by determining where light is transmitted through the transparent LC substrate.

For example, horizontally polarized ambient light 122 impinging upon the first polarizer 110 is allowed to pass while otherly polarized light is blocked. As described above, LCs in the target sub-pixels of the LC substrate that correspond to the digital content region are set to a light transmission state, and horizontally polarized light passing through these sub-pixels is altered. Specifically, the polarization of the light through these light-transmitting sub-pixels is changed to align with the polarization of the second polarizer (e.g., from horizontally polarized to vertically polarized). The light passing through the image pixels has thus been re-oriented and passes through the second polarizer 112 to the user.

By comparison, horizontally polarized ambient light 122 impinging on non-target sub-pixels is not altered and thus remains horizontally polarized. As such, this light is blocked by the second polarizer 112, which is vertical. Additional details regarding the transmission of ambient light 122 and supplemental light source light 124 through these layers are provided below in connection with FIGS. 7A and 7B.

In an example, the AR display device 100 not only allows ambient light 122 to transmit through in a pattern that matches the digital content but also colorizes the ambient light 122. Were the light allowed to pass but not be colorized, the user 102 may see the naturally-lit environment in the shape of the digital content, with other regions of the transparent LC substrate 108 being darkened. Accordingly, the AR display device 100 includes a multi-color filter 114, which in some examples is adjacent to a user-side polarizer (i.e., the second polarizer 112). The multi-color filter 114 may be a thin film that is adhered to the second polarizer 112. In general, the multi-color filter 114 is divided into sections. A section of the multi-color filter 114 aligns with a pixel of the transparent LC substrate 108. Each section may be divided into sub-sections. A sub-section of the multi-color filter 114 aligns with an individually addressable sub-pixel of the transparent LC substrate 108. Each sub-section includes a different color filter component, with one sub-section being free of a color filter component. For example, given a square color filter section, a first sub-section may include a red filter to allow transmission of red-colored ambient light and block transmission of other colored light. Similarly, a second sub-section may include a green filter to allow the transmission of green-colored ambient light and block the transmission of other colored light, and a third sub-section may include a blue filter to allow the transmission of blue-colored ambient light and block the transmission of other colored light. The fourth sub-section may not include any filter, so unfiltered ambient light may transmit through.

To colorize the digital content, transparent LC substrate 108 sub-pixels that correspond to a desired color for a transparent LC substrate 108 pixel may be set to a light transmission state. That is, as described above, the transparent LC substrate 108 is divided into pixels. In an example, the pixels are microscopic, so a user may not be able to differentiate between adjacent pixels. The digital content file may determine a per-pixel color for the digital content. For example, for a red navigational arrow, the content file may indicate, for each pixel, that the generated content at each target pixel should be red. In some examples, the digital content file may also indicate an intensity of the light at that pixel, which, as described above, may define a voltage value applied to the respective sub-pixel. In more complex cases, for example with multi-colored images, the content file may indicate a particular color for each target pixel that, when combined with the color designation of the thousands or millions of target pixels that make up the digital image, generate colored digital content.

Accordingly, in this example, to generate the target color at a target pixel, the controller 118 may set LCs corresponding to a sub-pixel that aligns with the target color sub-section of the color filter to a light transmission state. Returning to the example of a red navigational arrow. In this example, rather than setting all the sub-pixels of the target pixels (i.e., that define the red navigational arrow) to a light transmission state, the controller 118 may set just those sub-pixels that correspond to the red sub-sections to a light transmission state. LCs that align with other sub-sections of the color filter are set to an off state whereby light is not transmitted through. As such, the red arrow is generated as red ambient light in the shape of an arrow is allowed to transmit through to the user 102.

Put another way, the AR display device 100 includes a controller 118 that selectively sets LCs that align with target sub-pixels to a light transmission state, which target sub-pixels are 1) within a target pixel that is within a digital content region of the transparent LC substrate 108 and 2) define a color for the target pixel within the digital content region. Specifically, the controller 118 may electrify the LCs that align with the target sub-pixels in a way that alters the orientation of the LCs such that these LCs alter the polarization of impinging ambient light 122 to align with the second polarizer 112 and pass through a sub-section of the multi-color filter 114 to allow ambient light of a specific wavelength to pass through, which generates a colored pixel of the digital content.

By comparison, the controller 118 selectively sets LCs that align with the target pixel but do not align with the non-target sub-pixel to a light-blocking state. In the example above, the sub-pixels of the transparent LC substrate 108 that align with the green, blue, and transparent sub-sections of the multi-color filter 114 are set to a light-blocking state (i.e., the light transmitting through these sub-pixels is unaltered and therefore blocked by the second polarizer 112). As a result, red light is transmitted to the user 102, thus generating a colored pixel of the digital content.

When done for every target pixel and target sub-pixel that defines the boundaries and color of the digital content, a user 102 views colorized digital content illuminated by ambient light 122.

In an example, the AR display device 100 may further include an anti-reflective coating(s) to reduce glare to the user 102.

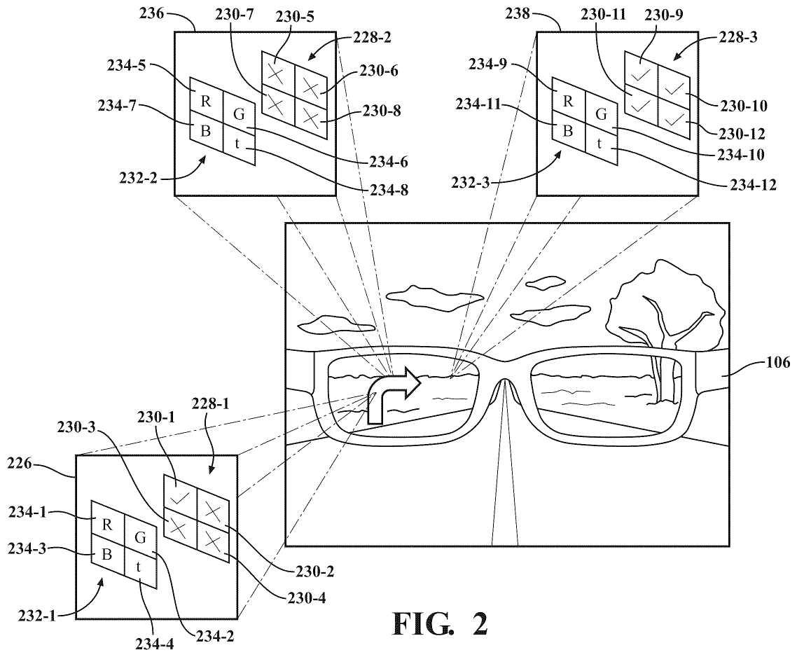

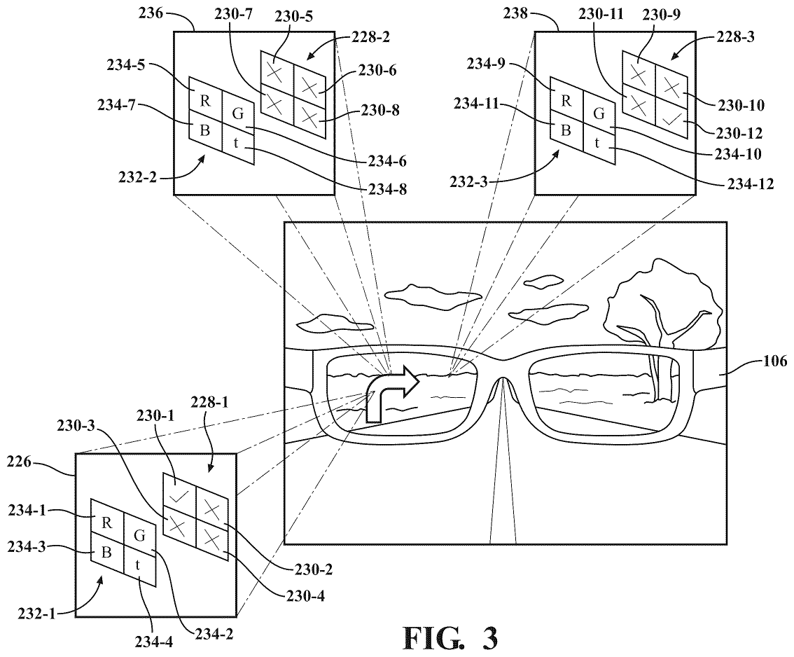

Additionally, the AR display device 100 improves the viewability of the digital content by setting LCs in sub-pixels that fall within a boundary region surrounding the digital image to a light-blocking state. Additional details regarding emphasizing the digital content by darkening boundary regions of the AR display device 100 are presented below in connection with FIGS. 2 and 3.

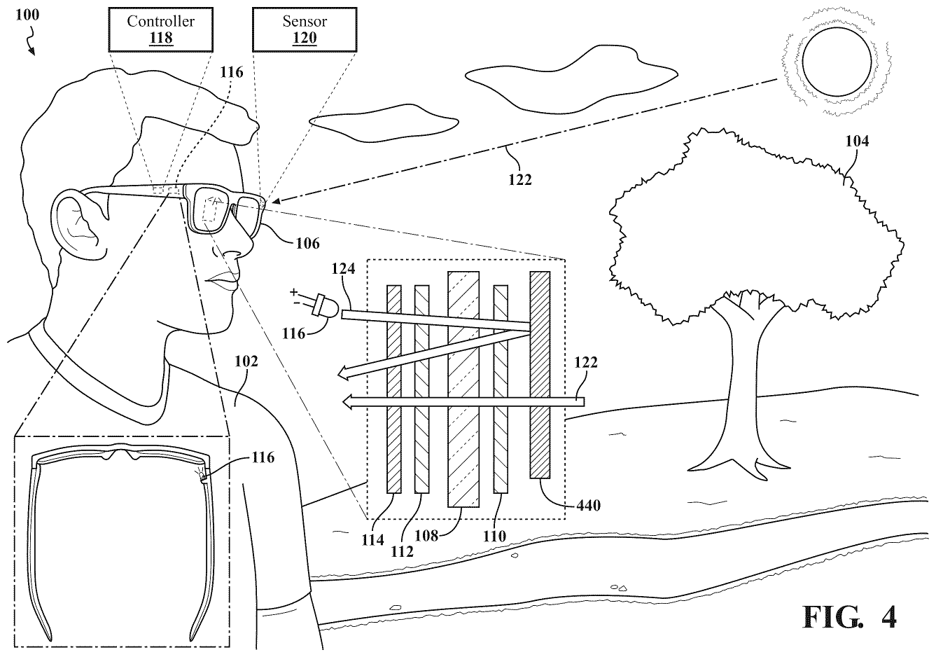

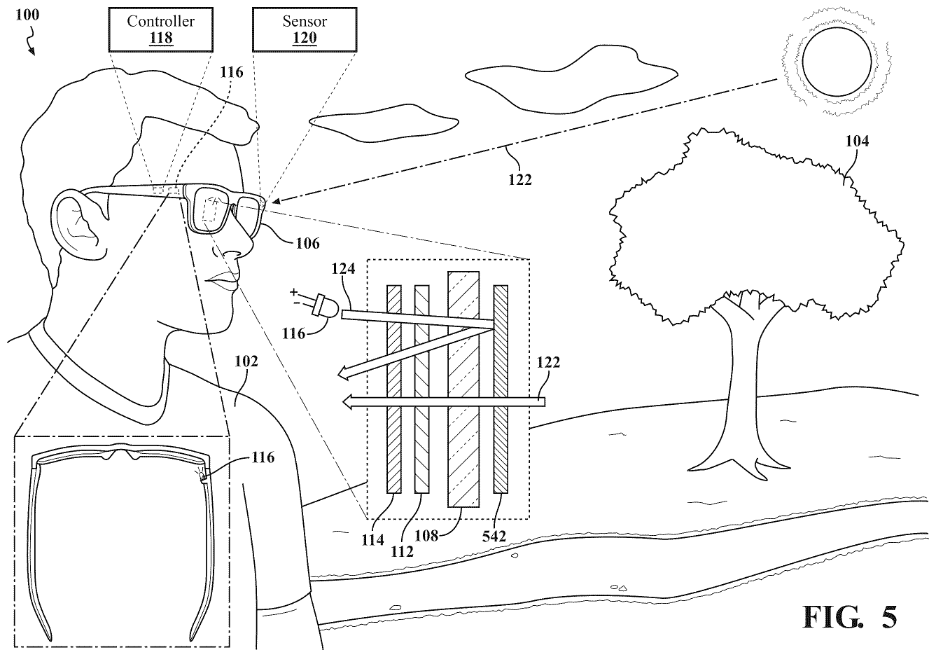

In some examples, the AR display device 100 includes a supplemental light source 116 mounted to the frame of the eyeglasses. That is, it may be that the ambient light 122 by itself does not sufficiently illuminate the target pixels to depict the digital content clearly. Accordingly, in this example, the AR display device 100 may include a supplemental light source 116 to increase the luminance of the digital content. As depicted in FIG. 1, in an example, the supplemental light source 116 may be mounted on a scene-facing side of the transparent LC substrate 108 and may be directed toward the user 102 through the transparent LC substrate 108. In other examples, for example, those that include a transflector (also referred to as a transflector, one-way mirror, or halfway mirror), such as depicted in FIGS. 4 and 5, the supplemental light source 116 may be mounted on a user-side of the transparent LC substrate 108. In either example, the supplemental light source light 124 may be altered by the polarizers 110 and 112, the transparent LC substrate 108, and the multi-color filter 114 as described above.

In an example, the AR display device 100 includes a sensor 120 coupled to the controller 118. The sensor 120 detects an amount of ambient light 122. When the ambient light 122 is below a predetermined level, which the user or manufacturer may define, the controller 118 may activate the supplemental light source 116 to provide additional illumination. The sensor 120 may take a variety of forms. For example, the sensor 120 may be an external-facing camera that provides an average intensity of the ambient light 122 from the scene. As another example, the sensor 120 may be colored photodetectors (e.g., photodetectors with colors in front that can identify the intensity of different bandwidths (RGB) of ambient light 122 from the scene). While particular reference is made to particular types of sensors 120, the sensor 120 may be of various types. In any case, the sensor 120 may determine the amount of each band of light, whether red, green, or blue, that is present.

In an example, as described above, in addition to triggering activation of the supplemental light source 116, the light intensity measurements, and in some cases the wavelength band intensity measurements, can be passed to the controller 118 to adjust the voltage on a per sub-pixel basis, where the sub-pixel determines the intensity of each transmitted color based on an orientation of the LCs in a respective sub-pixel.

Note that while FIG. 1 and others in the present specification depict the ambient light 122 as external natural sunlight, the AR display device 100 may be used indoors as well, where the ambient light 122 may be from artificial sources such as light bulbs, incandescent lights, or others.

Note also that while FIG. 1 and others depict a particular position of the multi-color filter 114 (i.e., on a user-side of a second polarizer 112), the multi-color filter 114 may be placed at other locations within the layered stack, such as between the second polarizer 112 and the transparent LC substrate 108, between the transparent LC substrate 108 and the first polarizer 110, and on a scene-side of the first polarizer 110.

Accordingly, the present AR display device 100 is low-power (due to a single active component, i.e., the transparent LC substrate 108 and the lack of a constantly active backlight to generate the digital image) and relies on passive light, i.e., sunlight or other ambient light 122, to generate the content rather than a sizeable external light source. For example, the present AR display device 100 may consume between 0.25 Watt hours (Wh) and 2 Wh, which is to say that the present AR display device 100 may consume between 0.25 Watts and 2 watts of power (e.g., 1 Wh) for one hour. By comparison, other AR display systems may consume between 3-16 Wh.

Moreover, by 1) actively setting non-target sub-pixels to a light-blocking state and 2) actively setting sub-pixels in a boundary region to a light-blocking state, the AR display device 100 generates an image 1) that has contrast with its immediate surroundings and 2) that is colorized.

FIG. 2 illustrates the state of various sub-pixels 230 of an AR display device 100 according to an example of the principles described herein. As described above, the AR display device 100 may take the form of eyeglasses worn by a user 102, which eyeglasses include a frame 106 in which layers of the AR display device 100 are mounted. As described above, the AR display device 100 may include a transparent LC substrate 108 through which the user views the environment and on which digital content is generated.

In general, FIG. 2 depicts the state of various sub-pixels 230-1-230-12 of the transparent LC substrate 108 and various sub-sections 234-1-230-12 of the multi-color filter 114 at various regions 226, 236, and 238. Note that a few instances of some elements are indicated with reference numbers for simplicity.

As described above, the transparent LC substrate 108 is divided into pixels 228-1, 228-2, and 228-3, which pixels 228-1, 228-2, and 228-3 are microscopic regions of the transparent LC substrate 108. For simplicity in FIG. 2, a few pixels 228-1, 228-2, and 228-3 are expanded. However, each pixel 228-1, 228-2, and 228-3 that makes up the transparent LC substrate 108 may be similarly configured (i.e., with sub-pixels). Each pixel 228-1, 228-2, and 228-3 is divided into sub-pixels 230-1-230-12, individually addressable via associated electrodes (as depicted in FIGS. 7A and 7B) and the controller 118.

Similarly, the multi-color filter 114 is divided into sections 232-1, 232-2, and 232-3, which sections 232-1, 232-2, and 232-3 are microscopic regions of the multi-color filter 114. For simplicity, in FIG. 2, a few sections 232-1, 232-2, and 232-3 are expanded. However, each section 232-1, 232-2, and 232-3 that makes up the multi-color filter 114 may be similarly configured (i.e., with sub-sections). Each section 232-1, 232-2, and 232-3 is divided into sub-sections 234-1-234-12. Each sub-section 234-1-234-12 pertains to either 1) a different color element or 2) a transparent element “t”. For example, first sub-sections 234-1, 234-5, and 234-9 of respective sections 232-1, 232-2, and 232-3 may transmit impinging ambient light having a wavelength that corresponds to the color red while blocking impinging ambient light having wavelengths that correspond to other colors. Similarly, second sub-sections 234-2, 234-6, and 234-10 of respective sections 232-1, 232-2, and 232-3 may transmit impinging ambient light having a wavelength that corresponds to the color green while blocking impinging ambient light having wavelengths that correspond to other colors and third sub-sections 234-3, 234-7, and 234-11 of respective sections 232-1, 232-2, and 232-3 may transmit impinging ambient light having a wavelength that corresponds to the color blue while blocking impinging ambient light having wavelengths that correspond to other colors. Lastly, fourth sub-sections 234-4, 234-8, and 234-12 of respective sections 232-1, 232-2, and 232-3 may allow any impinging ambient light to pass through. Note that while FIG. 2 depicts a particular arrangement between sub-sections and sub-pixels, other arrangements may be implemented in accordance with the principles described herein.

As described above, the AR display device 100 of the present specification sets the states of LCs in different sub-pixels 230-1-230-12 differently based on where the sub-pixel is located relative to the digital content to be presented. For example, LCs in the digital content region 226 are set to transmit and filter impinging ambient light 122 in a fashion to generate colored digital content, while LCs in the boundary region 236 are set to a light-blocking state to enhance the contrast and viewability of the digital content, and LCs in the region 238 surrounding the boundary region 236 are set to let all ambient light 122 pass through, unfiltered, so that a user 102 may perceive the environment 104 in its natural state.

In a specific example, the digital content file received at the controller 118 may define a red navigational arrow to be presented to the user 102. In this example, the controller 118 identifies those pixels 228-1 found in the digital content region 226, the digital content region 226 being the region/pixels of the transparent LC substrate 108 that defines the digital content, in this example, the red navigational arrow. In an example, the pixels 228-1 that define the digital content may be referred to as target pixels.

For example, the digital content may be represented in a matrix format, where each pixel corresponds to a specific location in the matrix. Each pixel may be defined by its color values (e.g., RGB). The digital content may be mapped to a coordinate system, for example, with an origin (0,0 being at a top-left corner with x-coordinates increasing towards the right and y-coordinates increasing vertically downward. Each pixel may be identified using its coordinates. For example, the pixel at position (x, y) may be referred to as pixel[x][y]. The identified target pixels can be stored in a data structure (like an array or list) that holds their coordinates for further processing or rendering. Once the target pixels are identified, the controller can manipulate them for display, such as changing their color, brightness, or visibility.

The digital content file may also indicate, per image pixel in the digital content region 226, the color of each image pixel. Based on this information, the controller 118 may activate the LCs in the sub-pixel 230 that align with the sub-section 234 that matches the target color for the image pixel. In an example, the sub-pixels 230 that are found within a target pixel 228-1 and that align with the filter color sub-section that matches the target color for that portion of the digital content may be referred to as target sub-pixels. For example, given that the first sub-section 234-1 matches the target color for this image pixel (e.g., red to match the red directional arrow to be generated), the controller 118 may set the sub-pixel 230-1 that aligns with the first sub-section 234-1 to a light transmission state. This first sub-pixel 230-1, on account of lining up with the first sub-section 234-1, may be referred to as a target sub-pixel 230-1. The controller 118 may set the LCs associated with the other (non-target) sub-pixels 230-2, 230-3, and 230-4 in the target pixel 228-1 to a light-blocking state. Accordingly, the light transmitted to the user 102 will have a red hue. This may be done for all target pixels 228-1 within the digital content region 226 to generate the red navigational arrow.

As described above, the controller 118 also sets LCs of the transparent LC substrate 108 that align with a boundary region 236 surrounding the digital content region 226 to a light-blocking state. Doing so may increase the contrast between the digital content and the surrounding environment, thus increasing the viewability of the digital content.

In this example, the controller 118 identifies those pixels 228-2 found in the boundary region 236, the boundary region 236 being the transparent LC substrate 108 region surrounding the digital content region 226. Based on this information, the controller 118 may set the LCs in each sub-pixel 230-5, 230-6, 230-7, and 230-8 in the boundary region 236 to a light-blocking state. As described above, in the light-blocking state, the LCs do not alter the polarization of the impinging ambient light 122, such that the impinging ambient light 122 is blocked by the second polarizer 112. The effect is that the boundary region 236 will appear dark to the user 102.

In an example, the boundary region 236 may be various sizes. For example, the boundary region 236 may be a predetermined quantity of pixels extending tangentially from the nearest target pixel 228-1 of the digital content region 226. In another example, the boundary region 236 distance may be a percentage of the width, length, or height of the digital content. In any case, the boundary region 236 may be a predetermined width boundary surrounding the digital content region 226.

In a region 238 outside of the boundary region 236, it may be desirable to let all ambient light 122 pass through so that the scene can be readily viewed without artificial colorization. Accordingly, the LCs in the region 238 outside the boundary region 236 may be set to a light transmission state. This may be achieved in a variety of ways. In one example, this may include setting all sub-pixels 230-9, 230-10, 230-11, and 230-12 in this region 238 in a light transmission state as depicted in FIG. 2. That is, the controller 118 may set the LCs of the transparent LC substrate 108 that are outside of the boundary region 236 and the digital content region 226 to a light transmission state. Specifically, the controller 118 identifies those pixels 228-3 found in the region 238 outside the boundary region 236. Based on this information, the controller 118 may set the LCs in each sub-pixel 230-9, 230-10, 230-11, and 230-12 of this region 238 to a light-transmission state. As described above, in the light transmission state, the LCs alter the polarization of the impinging ambient light 122, such that the impinging ambient light 122 is aligned with and transmits past the second polarizer 112. The effect is that the region 238 outside the boundary region 236 will appear naturally lit or dimmed due to the effect of the polarizers 110 and 112, to the user 102.

In the example depicted in FIG. 3, for pixels 228-3 in the region 238 outside the boundary region 236, the controller 118 may set the LCs in a sub-pixel 230-12 that aligns with a transparent sub-section 234-12 to a light transmission state and may set the LCs that align with other sub-pixels 230-9, 230-10, and 230-11 to a light-blocking state. That is, the controller 118 may set the LCs of the transparent LC substrate 108 that 1) are outside of the boundary region 236 and the digital content region 226 and 2) align with the transparent filter sub-section 234-12 to a light transmission state while LCs of sub-pixels 230-9, 230-10, and 230-11 that align with other sub-sections 234-9, 234-10, and 234-11 are set to a light-blocking state. The effect is that the region 238 outside the boundary region 236 will appear naturally lit to the user 102.

FIG. 4 illustrates one embodiment of an AR display device 100 with a transflector 440 according to an example of the principles described herein. As described above, in some examples, a supplemental light source 116 may provide additional luminance to the digital content to increase its viewability. In the example depicted in FIG. 1, the supplemental light source 116 is positioned on a scene side of the transparent LC substrate 108. In the example depicted in FIG. 4, the supplemental light source 116 may be mounted on the frame 106 on a user-facing side of the transparent LC substrate 108. As depicted in FIG. 4, the supplemental light source 116 and emitted supplemental light source light 124 may be directed away from the user 102.

Further in this example, the AR display device 100 may further include a transflector 440 on an environment-facing surface of a scene-side polarizer (e.g., the first polarizer 110). A transflector 440, which may be referred to as a transflector, transreflector, halfway mirror, or one-way mirror, is partially reflective, such that a portion of the ambient light 122 from one direction (from the scene side of the transflector 440 toward the user 102) is transmitted and a portion of the ambient light 112 is reflected. Light from another direction (from the user side of the transflector 440 toward the transflector 440) is also transmitted and reflected. In other words, the transflector 440 transmits a portion of the light in either direction and reflects another portion of the light in either direction.

Although a portion of the ambient light 122 is reflected, a portion of the ambient light 122 is transmitted through the transparent LC substrate 108. Accordingly, the user 102 can still see objects in the environment 104. The transflector 440 reduces the amount of ambient light 122 that is transmitted (on account of a portion of the ambient light 122 being reflected), which increases the display brightness for the user 102. Similarly, while a portion of the supplemental light source light 124 is transmitted, a portion is reflected, which provides supplemental light as needed to increase the brightness/contrast of the digital content.

In this example, the supplemental light source light 124 is reflected off the transflector 440 toward the user 102 to provide the additional illumination that low-light conditions may trigger. In an example, the transflector 440, may be a semi-reflective film on the environment side of the transparent LC substrate 108. In an example, the transflector 440 may include reflective layers (such as silver) sparsely applied over the user-facing surface of a substrate, but covering a portion (e.g., half) of that surface. As such, the reflective layers reflect some light (e.g., the supplemental light source light 124) from the user side, while transmitting other light (e.g., the ambient light 122) from the other direction. In another example, the semi-transparent transflector 440 may be a reflector with an aperture per pixel, allowing the ambient light 122 to pass through.

In this example, the AR display device 100 includes components similar to those described above, such as the controller 118, sensor 120, multi-color filter 114, first and second polarizers 110 and 112, and the transparent LC substrate 108.

FIG. 5 illustrates one embodiment of an AR display device 100 according to an example of the principles described herein. In the example depicted in FIG. 5, the transflector 440 is integrated with the scene-side, or second, polarizer 112. Specifically, the AR display device 100 includes a reflective polarizer 542. Generally, a reflective polarizer transmits light with a target polarization (e.g., vertical) and reflects light with a different polarization. A reflective polarizer 542 may be a wire grid polarizer that creates magnetic dipoles that reflect light. Light polarized along the wires is reflected, while polarized light perpendicular to the wires is transmitted.

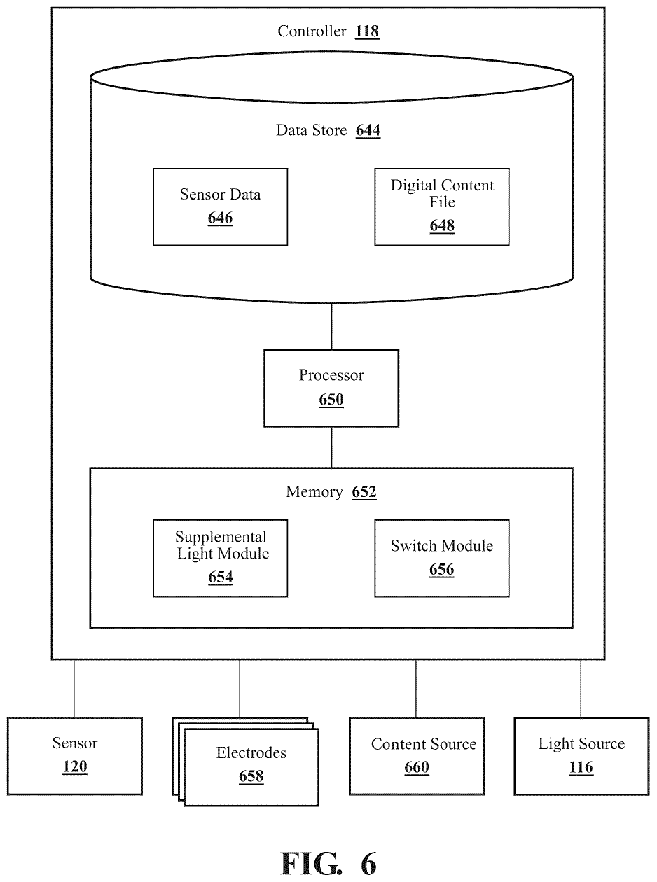

FIG. 6 illustrates one embodiment of the controller 118 of the AR display device 100 according to an example of the principles described herein. As described above, the controller 118 selectively sets the LCs 764 in the transparent LC substrate 108 to either a light transmission state or a light-blocking state based on a particular digital content file 648.

The controller 118 includes one or more processors 650. In one or more arrangements, the processor(s) 650 can be a primary/centralized processor or may be representative of many distributed processing units.

Moreover, in one embodiment, the controller 118 includes the data store 644. The data store 644 is, in one embodiment, an electronic data structure stored in the memory 652 or another data storage device and that is configured with routines that can be executed by the processor 650 for analyzing stored data, providing stored data, organizing stored data, and so on. Thus, in one embodiment, the data store 644 stores data used by the modules 654 and 656 in executing various functions.

The data store 644 can be comprised of volatile and/or non-volatile memory. Examples of memory that may form the data store 644 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 644 is a component of the processor(s) 650. In general, the data store 644 is operatively connected to the processor(s) 650 for use thereby. The term “operatively connected,” as used throughout this description, can include direct or indirect connections, including connections without direct physical contact.

In one embodiment, the data store 644 stores the sensor data 646 along with, for example, metadata that characterizes various aspects of the sensor data 646. The sensor data 646 may be collected by a sensor 120, such as an external-facing camera, colored photodetectors, or a luminance sensor. As described above, in some scenarios, such as low-light conditions, the supplemental light source 116 may be activated to provide additional luminance to the digital content, thus increasing its viewability. In one specific example, the sensor 120 may be a photodetector, and the sensor data 646 may be measures of ambient light, for example, measured as a luminous flux per unit area over time. Accordingly, the sensor data 646 may include data measurements collected by the sensor 120 regarding an amount of ambient light 122.

As described above, the sensor data 646 may also include data indicating an intensity or amount of different wavelengths of light. For example, the sensor 120 may determine the intensity of red, green, and blue wavelengths of light. This information, in addition to triggering activation of the supplemental light source 116, may be used to determine the voltage applied to the electrodes and the corresponding orientation of the LCs to adjust the intensity of the light transmitted through the transparent LC substrate 108.

In one embodiment, the data store 644 further includes digital content files 648. As described above, the digital content files 648 define the digital content to be created. In an example, the digital content files 648 identify those pixels that define the digital content. The digital content file 648 may also include a pixel-based indication of color for the digital content. That is, the digital content file 648 may define the content to be presented and may include data indicating a color for each pixel of the digital content. That is, digital content is divided into pixels, each having a particular color value. The digital content file 648 may indicate the pixels that make up the image, for example, through an identifier or address, and a color associated with each pixel.

As described above, this information is used by the switch module 656 to determine which sub-pixels to activate to generate the colored digital content. That is, the controller 118 receives this digital content file 648 from a content source 660, analyzes such, and identifies those pixels of the transparent LC substrate 108 that map to the pixels of the digital content and identifies a target color for the target pixel 228-1. The switch module 656 then identifies the LCs within the target pixels 228-1 and sets them to a light transmission state. Accordingly, the data store 644 includes the digital content files 648 received from a content source 660, such as a remote server, which digital content files 648 describe and define the digital content to be created on the AR display device 100.

The controller 118 also includes memory 652 that stores a supplemental light module 654 and a switch module 656. The memory 652 is a random-access memory (RAM), read-only memory (ROM), a hard-disk drive, a flash memory, or another suitable memory for storing the modules 654 and 656. The modules 654 and 656 are, for example, computer-readable instructions that, when executed by the processor 650, cause the processor 650 to perform the various functions disclosed herein. In alternative arrangements, modules 654 and 656 are independent elements from the memory 652 that are, for example, comprised of hardware elements. Thus, the modules 654 and 656 are alternatively application-specific integrated circuits (ASICs), hardware-based controllers, a composition of logic gates, or another hardware-based solution.

In at least one arrangement, the modules are implemented as non-transitory computer-readable instructions that, when executed by the processor 650, implement one or more of the various functions described herein. In various arrangements, one or more of the modules are a component of the processor(s) 650, or one or more of the modules are executed on and/or distributed among other processing systems to which the processor(s) 650 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

The supplemental light module 654, in one embodiment, includes instructions that cause the processor 650 to 1) detect an amount of ambient light 122 and 2) activate the supplemental light source 116 responsive to the amount of ambient light 122 being below a predetermined level. That is, as described above, sensor data 646 may indicate a measured amount of ambient light 122 in an environment. The supplemental light module 654 may compare the measured amount of ambient light 122 to some predetermined level, which may be stored in the data store 644 and set by a user or determined empirically. For example, a user may be presented with digital content under various lighting conditions and prompted to indicate when the digital content is difficult to see. When the user 102 indicates the digital content is difficult to see, the luminance level may be identified as the predetermined level where the supplemental light source 116 is to be activated. When measured ambient light 122 levels are greater than the predetermined amount, the supplemental light module 654 may retain the supplemental light source 116 in an off state. In another example, the supplemental light module 654 may activate the supplemental light source 116 based on user input. That is, the user 102 may manually activate the supplemental light source 116 to provide additional illumination.

The switch module 656, in one embodiment, includes instructions that cause the processor 650 to selectively set LCs that align with target sub-pixels to a light transmission state. Specifically, the switch module 656 includes instructions that cause the processor 650 to transmit an activating electrical current to the transparent electrodes 658 associated with LCs to be set. As described above, a target sub-pixel is within a digital content region 226 of the transparent LC substrate 108 and defines a color for a target pixel 228-1 within the digital content region 226. The switch module 656 also includes instructions that cause the processor 650 to selectively set LCs that align with non-target sub-pixels to a light-blocking state. That is, the switch module 656, relying on the digital content file 648 for digital content to be presented, may identify the target pixels 228-1 of the transparent LC substrate 108 that pertain to the digital content and the target sub-pixels within a target pixel 228-1 that aligns with a multi-color filter sub-section color that matches a target color for the target pixel 228-1. The switch module 656 may then set the LCs in the target sub-pixels to a light transmission state or light blocking state as described above. That is, the switch module 656 may selectively apply an electrical current to particular LCs based on their association with certain target sub-pixels that define the digital content and the color of the digital content at the respective target pixel 228-1.

The switch module 656 also includes instructions that cause the processor 650 to selectively set LCs of the transparent LC substrate 108 that align with a boundary region 236 surrounding the digital content region 226 to a light-blocking state as described above.

The switch module 656 also includes instructions that cause the processor 650 to 1) set the LCs of the transparent LC substrate 108 that are outside of the boundary region 236 and the digital content region 226 to a light transmission state or 2) set the LCs of the transparent LC substrate 108 that are outside of the boundary region 236 and the digital content region 226 that align with a transparent filter sub-section of the multi-color filter 114 to a light transmission state while other filter sub-sections of the multi-color filter 114 are set to a light-blocking state.

As such, the controller 118 communicates with various components to perform the above-described operations. Specifically, the controller 118 receives sensor data 646 from the sensor 120 and digital content files 648 from a content source 660. Moreover, the controller 118 communicates with the supplemental light source 116 and the transparent electrodes 658 associated with different LCs. Accordingly, the controller 118 functions in cooperation with a communication system. In one embodiment, the communication system communicates according to one or more communication standards. For example, the communication system can include multiple different antennas/transceivers and/or other hardware elements for communicating at different frequencies and according to respective protocols. The communication system, in one arrangement, communicates via a communication protocol, such as a WiFi, dedicated short-range communication (DSRC), or another suitable protocol for communicating between the content source 660. Moreover, the communication system, in one arrangement, further communicates according to a protocol, such as global system for mobile communication (GSM), Enhanced Data Rates for GSM Evolution (EDGE), Long-Term Evolution (LTE), 5G, or another communication technology that provides for the controller 118 communicating with various remote devices (e.g., content sources 660). Moreover, the controller 118 may include wired connections to various on-frame components such as the sensors 120, transparent electrodes 658, and the supplemental light source 116.

FIGS. 7A and 7B depict the polarizers 110 and 112 and the transparent LC substrate 108 of the AR display device 100, according to an example of the principles described herein. Specifically, FIG. 7A depicts the liquid crystals 764 of an individual sub-pixel in a light transmission state where the LCs 764 adjust the polarization of incoming light. By comparison, FIG. 7B depicts the liquid crystals 764 of an individual sub-pixel in a light-blocking state where the LCs 764 do not adjust the polarization of incoming light. For simplicity, the LCs 764 in FIGS. 7A and 7B have been enlarged. The matrix material 762 may include more of these microscopic orientation-changing LCs 764.

As described above, the transparent LC substrate 108 includes liquid crystals 764 that are switchable to selectively allow light to change the polarization of impinging light. In general, the orientation of the LCs 764 within a matrix material 762 may be switched, which orientation affects how light propagates through the transparent LC substrate 108. Combined with the polarizers 110 and 112, the system may selectively filter light directed toward the user 102 through the AR display device 100. In an example, the LCs 764 in a transflective system may have a higher refractive index than liquid crystal systems with refractive indexes that match glass. As such, a transflective AR display device may increase the reflection. In an example, the liquid crystals may be bistable.

In an example, either the light transmission state or the light blocking state may be defined by an applied electrical current. For example, it may be that an electrical current is applied to place the LCs 764 in the light transmission state, whereas when no current is applied, the LCs 764 are light-blocking. By comparison, it may be that an electrical current is applied to place the LCs 764 in the light-blocking state, whereas when no current is applied, the LCs 764 are in a light transmission state.

In either case, the electrical current may be applied by a matrix of thin-film transparent electrodes 658-1 and 658-2 on either side of a matrix material 762 in which the LCs 764 are disposed. That is, the transparent LC substrate 108 may include an active matrix of transparent electrodes or transparent thin film transistors, which may be formed of a material such as indium tin oxide (ITO). A pair of these transparent electrodes 658-1 and 658-2 activate a corresponding sub-pixel. That is, via the transparent electrodes 658-1 and 658-2, the controller 118 applies an electrical current across the matrix material 762 to place the LCs 764 in a particular state (e.g., light blocking or light transmission). As depicted in FIGS. 7A and 7B, each sub-pixel 230 may include a pair of transparent electrodes 658-1 and 658-2 such that each sub-pixel 230 is individually actuatable to a light transmission or light-blocking state.

In an example, each sub-pixel 230 is paired with a dedicated transistor and capacitor. The transistor controls the sub-pixel's state by applying a voltage, and the capacitor holds this charge until the next refresh cycle.

As depicted in FIGS. 7A and 7B, ambient light 122 (which may naturally have light beams that are vertically polarized, light beams that are horizontally polarized, and light beams that are polarized at different angles) impinges upon the first polarizer 110 of the AR display device 100. The first polarizer 110, which may be a horizontal polarizer, allows horizontally polarized ambient light 122 to transmit through while blocking vertically polarized ambient light 122. If the LCs 764 are set in a light transmission state, as depicted in FIG. 7A, the LCs 764 orientation is changed in such a way as to alter the polarization of the ambient light 122 exiting the transparent LC substrate 108. The particular orientation for the LCs 764 that results in second polarizer-aligned light waves may be defined by the parameters of the electrical current. Accordingly, a particular frequency and intensity of electrical current may be applied so that the orientation of the LCs 764 results in exiting light waves with a polarity that matches that of the second polarizer 112. The specific parameters of the electrical current may vary based on multiple criteria, including material properties of the matrix material 762 and a type of liquid crystal 764. In any case, the orientation of the LCs 764 in target sub-pixels 230 is altered such that the exiting ambient light 122 has a polarization that matches the polarity of the second polarizer 112 (e.g., from horizontal to vertical as depicted in FIG. 7A). As such, as depicted in FIG. 7A, the second polarizer 112 (e.g., the vertical polarizer) allows the vertically polarized ambient light 122 to pass through to the user 102.

By comparison, if the LCs 764 are set in a light-blocking state, as depicted in FIG. 7B, the LCs 764 orientation is not changed, so the polarization of light exiting the sub-pixel remains as it was when entering it. In the example depicted in FIG. 7B, the light remains horizontally polarized, which is blocked by the second polarizer 112 (e.g., the vertical polarizer). Accordingly, this region of the AR display device 100 may appear dark. Again, while FIGS. 7A and 7B depict a particular polarization for the polarizers 110 and 112 (i.e., the first polarizer 110 is a horizontal polarizer, and the second polarizer 112 is a vertical polarizer), the polarizers 110 and 112 may have different polarizations than those depicted (i.e., the first polarizer 110 may be a vertical polarizer and the second polarizer 112 may be a horizontal polarizer).

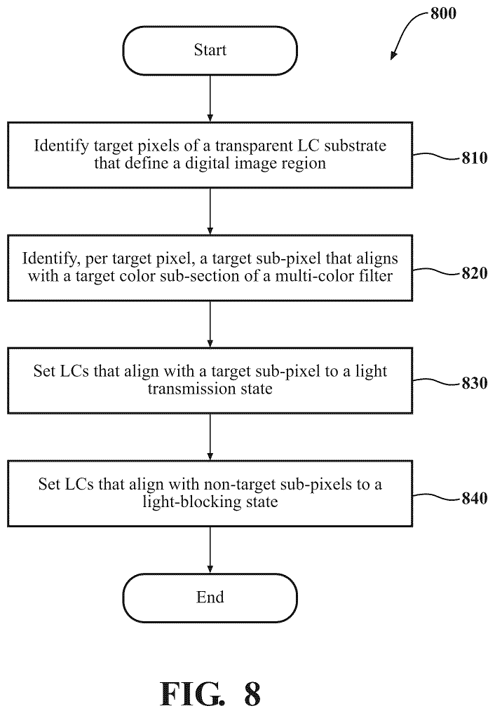

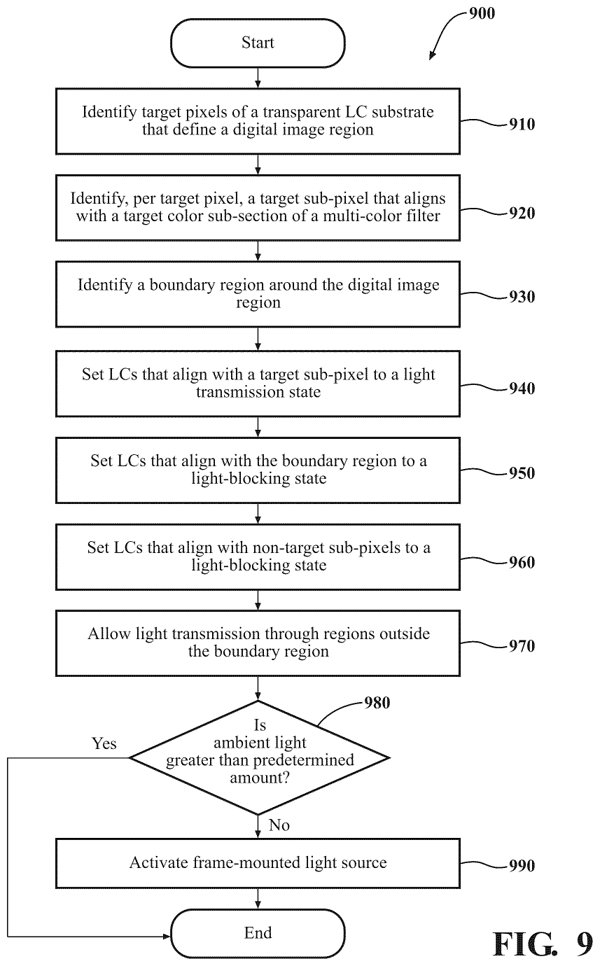

Additional aspects of AR display will be discussed in relation to FIGS. 8 and 9. FIGS. 8 and 9 illustrate flowcharts of methods 800 and 900 that are associated with presenting high-contrast computer-generated content. Methods 800 and 900 will be discussed from the perspective of the AR display device 100 of FIG. 1. While methods 800 and 900 are discussed in combination with the AR display device 100, it should be appreciated that the methods 800 and 900 are not limited to being implemented within the AR display device 100 but is instead one example of a system that may implement the methods 800 and 900.

At 810, the method 800 includes identifying target pixels 228-1 of a transparent LC substrate 108, which target pixels 228-1 define a digital content region 226 of the transparent LC substrate 108. That is, as described above, digital content may be defined by content pixels in a digital content file 648. The controller 118 may map the content pixels to associated regions on the transparent LC substrate 108 to be set to a light transmission state. That is, the controller 118 receives a digital content file 648 and from such extracts those pixels, or regions, of the transparent LC substrate 108 that make up the digital content.

At 820, the method 800 includes identifying, per target pixel 228-1, a target sub-pixel that aligns with a color sub-section of a multi-color filter 114 that matches a target color for the target pixel 228-1. That is, in addition to defining the pixels that make up digital content, the digital content file 648 may indicate a target color for each target pixel 228-1. A multi-color filter 114 includes sections, each of which includes multiple sub-sections that include color-specific filters (e.g., R, G, B, and transparent). Accordingly, the controller 118 may determine a color for a particular target pixel 228-1 and identify the sub-pixel of the target pixel 228-1 that aligns with the color-specific sub-section of the multi-color filter 114.

At 830, the method 800 includes setting LCs 764 of the transparent LC substrate 108 that align with the target sub-pixel to a light transmission state. This may include setting the LCs 764 of the transparent LC substrate 108 that align with the target sub-pixel to a state where the LCs 764 change a polarization of ambient light 122 from a scene-side polarizer (e.g., a first polarizer 110) to match an orientation of a user-side polarizer (e.g., a second polarizer 112) such that light transmits through the target pixels 228-1 of the transparent LC substrate 108.

At 840, the method 800 includes setting LCs 764 that align with non-target sub-pixels to a light-blocking state. This may include setting the LCs 764 that align with the non-target sub-pixels to maintain a polarization of ambient light 122 from a scene-side polarizer (e.g., the first polarizer 110), such that the user-side polarizer blocks light. For example, for a green diamond to be displayed on the transparent LC substrate 108, the controller 118 may identify target pixels 228-1 of the transparent LC substrate 108 that are to form the green diamond, and for each target pixel 228-1, activate the LCs 764 in the sub-pixels that align with the green sub-section of the associated multi-color filter 114 section as described above. At the same time, the controller 118 may set the LCs 764 in non-target sub-pixels of the target pixel 228-1 (e.g., the red sub-section, blue sub-section, and transparent sub-section) to a light-blocking state. Accordingly, in this example, any ambient light 122 that is transmitted through the AR display is through 1) target pixels 228-1 that define an area of the digital content and 2) target sub-pixels that direct light through appropriate color filter sub-sections as defined by the digital content file 648.

The method 900 depicts additional operations. First, as described above, at 910 the method 900 includes identifying target pixels 228-1 of a transparent LC substrate 108 that define a digital content region 226, and at 920 the method 900 includes identifying, per target pixel 228-1, a target sub-pixel that aligns with a target color sub-section of the multi-color filter 114.

At 930, the method 900 includes identifying a boundary region 236 that surrounds the digital content region 226. This boundary region 236 may be a predetermined or adjustable boundary that surrounds the edges of the digital content to be presented. In an example, this may be performed by identifying those pixels, by address, that are outside of the digital content region 226 within a certain pixel distance. Each pixel may be identified by an address indicating its position on the transparent LC substrate 108. Via these addresses, the controller 118 may identify those pixels in the digital content region 226 and those within the boundary region 236.

As described in regards to FIG. 8, at 940 the method 900 includes setting LCs 764 that align with a target sub-pixel to a light transmission state. At 950, the method 900 includes setting LCs 764 that align with the boundary region 236 to a light-blocking state.

As described in regards to FIG. 8, at 960, the method 900 includes setting LCs 764 that align with non-target sub-pixels to a light-blocking state. At 970, the method 900 includes allowing light transmission through regions 238 outside the boundary region 236. For example, as depicted in FIGS. 5 and 6, the controller 118 may either set all sub-pixels to a light transmission state or set sub-pixels that align with a transparent sub-section of the multi-color filter 114 to a light transmission state.

At 980, the controller 118 may determine, based on sensor data 646 from the sensor 120, whether the amount of ambient light 122 is greater than a predetermined level. If so, the method 900 may end. If not, at 990, the method 900 may include activating a frame-mounted supplemental light source 116 to provide additional luminance.

Accordingly, the methods 800 and 900 provide low-power digital content presentation on account of eliminating a high energy-consuming external light source and implementing a simplified controller 118. Moreover, the methods 800 and 900 provide easily viewable information by selectively setting non-target sub-pixels of the transparent LC substrate 108 to a light-blocking state.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An augmented reality (AR) display device, comprising:
a transparent liquid crystal (LC) substrate divided into pixels that comprise individually addressable sub-pixels;
a set of oppositely-polarized polarizers, a polarizer on either side of the transparent LC substrate;
a multi-color filter, the multi-color filter is divided into sections that comprise sub-sections, a sub-section aligns with an individually addressable sub-pixel; and
a controller that selectively sets:
LCs that align with target sub-pixels to a light transmission state, a target sub-pixel is within a digital content region of the transparent LC substrate and defines a color for a target pixel within the digital content region; and
LCs that align with non-target sub-pixels to a light-blocking state.

2. The AR display device of claim 1, further comprising:
a frame to be worn on a head of a user; and
a supplemental light source mounted to the frame.

3. The AR display device of claim 2:
further comprising a transflector on an environment-facing surface of a scene-side polarizer; and
the supplemental light source is mounted on a user-facing side of the transparent LC substrate and is directed away from the user.

4. The AR display device of claim 3, wherein the transflector is integrated with the scene-side polarizer.

5. The AR display device of claim 2, wherein the supplemental light source is mounted on a scene side of the transparent LC substrate and is directed toward the user through the transparent LC substrate.

6. The AR display device of claim 1:
further comprising a sensor to detect an amount of ambient light; and
wherein the controller is adapted to activate a supplemental light source responsive to the amount of ambient light being below a predetermined level.

7. The AR display device of claim 1, wherein the controller selectively sets LCs of the transparent LC substrate that align with a boundary region surrounding the digital content region to the light-blocking state.

8. The AR display device of claim 7 wherein the controller:
sets LCs of the transparent LC substrate that are outside of the boundary region and the digital content region to the light transmission state; or
sets LCs of the transparent LC substrate that are outside of the boundary region and the digital content region and that align with a transparent sub-section of the multi-color filter to the light transmission state, while other sub-sections of the multi-color filter are set to the light-blocking state.

9. An augmented reality (AR) display device, comprising:
a frame to be worn on a head of a user;
a supplemental light source mounted to the frame;
a transparent liquid crystal (LC) substrate divided into pixels that comprise individually addressable sub-pixels;
a set of oppositely-polarized polarizers, a polarizer on either side of the transparent LC substrate;
a multi-color filter adjacent to a user-side polarizer, the multi-color filter is divided into sections that comprise sub-sections, a sub-section aligns with an individually addressable sub-pixel; and
a controller that selectively sets:
LCs that align with target sub-pixels to a light transmission state, a target sub-pixel is within a digital content region of the transparent LC substrate and defines a color for a target pixel within the digital content region; and
LCs that align with non-target sub-pixels to a light-blocking state.

10. The AR display device of claim 9:
further comprising a transflector on an environment-facing surface of a scene-side polarizer; and
the supplemental light source is mounted on a user-facing side of the transparent LC substrate and is directed away from the user.

11. The AR display device of claim 10, wherein the transflector is integrated with the scene-side polarizer.

12. The AR display device of claim 10, wherein the supplemental light source is mounted on a scene-facing side of the transparent LC substrate and is directed toward the user through the transparent LC substrate.

13. The AR display device of claim 9:
further comprising a sensor to detect an amount of ambient light; and
wherein the controller is adapted to activate the supplemental light source responsive to the amount of ambient light being below a predetermined level.

14. The AR display device of claim 9:
wherein the controller selectively sets LCs of the transparent LC substrate that align with a boundary region surrounding the digital content region to the light-blocking state; and
wherein the controller:
sets LCs of the transparent LC substrate that are outside of the boundary region and the digital content region to the light transmission state; or
sets LCs of the transparent LC substrate that are outside of the boundary region and the digital content region and that align with a transparent sub-section of the multi-color filter to the light transmission state, while other sub-sections of the multi-color filter are set to the light-blocking state.

15. A method, comprising:
identifying target pixels of a transparent liquid crystal (LC) substrate, the target pixels define a digital content region of the transparent LC substrate;
identifying, per target pixel, a target sub-pixel that aligns with a color sub-section, of a multi-color filter that overlays the transparent LC substrate, that matches a target color for the target pixel;
setting LCs of the transparent LC substrate that align with the target sub-pixel to a light transmission state; and
setting LCs that align with non-target sub-pixels to a light-blocking state.

16. The method of claim 15, further comprising:
identifying a boundary region around the digital content region; and
setting LCs of the transparent LC substrate that align with the boundary region to the light-blocking state.

17. The method of claim 16, further comprising setting LCs of the transparent LC substrate that are outside of the boundary region and the digital content region to the light transmission state.

18. The method of claim 16, further comprising setting LCs of the transparent LC substrate that are outside of the boundary region and the digital content region and that align with a transparent sub-section of the multi-color filter to the light transmission state while other sub-sections of the multi-color filter are set to the light-blocking state.

19. The method of claim 15, further comprising:
detecting an amount of ambient light; and
activating a supplemental light source responsive to the amount of ambient light being below a predetermined level.

20. The method of claim 15, wherein:
setting LCs of the transparent LC substrate that align with the target sub-pixel to the light transmission state comprises setting LCs of the transparent LC substrate that align with the target sub-pixel to change a polarization of light through a scene-side polarizer to match an orientation of a user-side polarizer such that light transmits through the target sub-pixels of the transparent LC substrate; and
setting LCs that align with non-target sub-pixels to the light-blocking state comprises setting LCs of the transparent LC substrate that align with the non-target sub-pixels to maintain the polarization of light through the scene-side polarizer such that the scene-side polarizer blocks light through the transparent LC substrate.
